(19) United States
(12) Patent Application Publication
(10) Pub. No.: US 2007/0055694 A1
(43) Pub. Date: Mar. 8, 2007

(54) System and method for providing a unified customer feedback solution

(75) Inventors: Dustin W. Ruge, St. James, NY (US); Milan Negovan, Hauppauge, NY (US); Ronnie Paul Pisani, Floral Park, NY (US)

Correspondence Address: KEUSEY, TUTUNJIAN & BITETTO, P.C., 20 CROSSWAYS PARK NORTH, SUITE 210, WOODBURY, NY, 11797, US

(73) Assignee: CUSTOMER FEEDBACK SOLUTIONS, Inc.

(21) Appl. No.: 11/207,219

(22) Filed: Aug. 19, 2005

(51) Int. Cl. G06F 17/00

(52) U.S. Cl. 707/104.1

(57) ABSTRACT

A method for providing a system for allowing businesses to manage substantially all of their customer relations and feedback on a computer network via a Customer Feedback System, where the method includes providing a software framework supporting multiple client modules, enabling/disabling client modules individually, maintaining a set of client modules, customizing a user interface, and processing user requests and/or feedback data for a client.

### BACKGROUND

1. Technical Field

The present invention relates generally to the field of electronic customer relations management, and more specifically to a system for integrating customer feedback and employee knowledge management.

2. Description of the Related Art

Analysts have estimated that acquiring new customers costs as much as six times more than retaining existing customers. In service related industries, the quality of customer service is one of the foremost commodities. Therefore, it would be most advantageous for businesses to retain the existing customers by providing them with superior service.

Several of the ways businesses attempt to increase customer service quality include customer satisfaction surveys, lower customer service response times, and increased customer communication. Customer satisfaction surveys are frequently a method companies use to improve the service levels existing customers experience with businesses. Recently, many companies have moved to surveying their customers over the Internet. This allows companies to survey customers more rapidly and accurately, and aggregate survey results more coherently.

It is, however, desirable to complete as much customer interaction as possible via the Internet. Allowing customers to find as much information about a problem themselves can help reduce call center volume, and reduce ongoing costs associated with customer service.

A need exists for a product that manageably integrates two or more of the aspects of customer service in a way that delivers a unified look and feel, high customer satisfaction, centralized management and ease of use.

### SUMMARY OF THE INVENTION

A method for installing and enabling a Customer Feedback System delivered through a digital delivery means. The method may include providing a software framework for supporting customer feedback client modules, enabling or disabling the modules individually, maintaining the modules, processing user requests and/or feedback data and processing customer data for a client.

The Customer Feedback System may provide users with a user interface having a theme or look that is unified across the entire Customer Feedback System, and which theme may also be coordinated with a customer's existing website. Additionally, the Customer Feedback System may also provide access to a plurality of client module, each module providing functionality to support customer feedback interaction with users.

A Customer Feedback system provider may license, lease or sell software for running a Customer Feedback System. The provider may also provide a computer server or network system for executing or accessing functionality of the Customer Feedback System, the fee for the computer server or network built into the software licensing fee or sale price, or the fee billed separately from the cost of the software.

The Customer Feedback System provider may maintain client modules by supplying network resources or computer servers for hosting the Customer Feedback System, administering the Customer Feedback System, consulting on the design and features of the Customer Feedback System, and monitoring the Customer Feedback System on behalf of a client.

The Customer Feedback System may also provide optimal usability by including a database cache to speed database read operations. The database cache may cache data by setting a timer interval, starting the timer, activating a polling module upon timer interval elapsing, calling a database dependency manager which determines which database objects a needed to update the database cache, generating checksums for each database object, comparing the new checksums against previously generated checksums, loading into the cache from the database any database object for which the new and previous checksums differ, saving the most current checksums, and shutting down the polling module.

Additionally, the Customer Feedback System may employ a String Localization module to allow easier regional customization of the user interface by localizing user interface strings into specified languages. This String Localization module may localize strings in outbound response data by parsing the response data, instantiating any needed controls, using a custom class to analyze each control for a predefined text pattern, reading the text inside each predefined text pattern, searching a file for text matches and associated localized text, replacing any found predetermined text patterns in the control with the associated localized text, and adding the localized control to the control tree. The String Localization module may use a resource file containing text patterns and associated localized text strings, which are presented in one or more languages, with the language displayed being selected by the user.

The Customer Feedback System may also provide access to a database driven file system or a Virtual File System which may provide a familiar, hierarchical interface for accessing files and folders stored in a database. The Virtual File System may allow access to requested files stored in the file system by receiving and then validating a user's login credentials, receiving a request for a file or folder, restricting or granting access to the requested file or folder based on previously set permission associate with the user's login credentials, redirecting non-authorized users to another web page and granting access to authorized users by loading then transmitting the requested file or folder to the requesting user. The Virtual File System may also allow a system administrator to set user permissions by creating a directory structure for the storage of files and folders, designating which network resources are allowed to submit data to the Virtual File System, populating the directory structure with files and folders, configuring permissions identifying which network resources a user may access, and then saving the directory structure, its contents and user permissions to a database.

To provide additional security, the Customer Feedback System may also employ an URL Scan module to verify that users accessing a Customer Feedback System web page are being referred from a site allowed under predefined URL Scan module rules. The URL Scan module restricting user access may include determining the referring network resource, finding rules defined for the referring network resource and requested network resource, allowing access if such a rule is defined, allowing access to the requested network resource if users are allowed unauthorized access, and redirecting users to an alternate network resource if no unauthorized access rule or referrer/requested resource rule is defined.

Additionally, the Customer Feedback System may provide access to a Software Evaluator Auto-Recruitment module, which may be configured as a client module supported by the Customer Feedback System. This Software Evaluator Auto-Recruitment module may provide Customer Feedback System clients with an automated method for performing steps of software evaluator recruitment, qualification, signup, and authentication. This automated method may be configured by an administrator who specifies software testing program qualifications and requirements, then generates a URL indicating an internet address where users may register to become software testers. The automated recruitment process may then qualify and register prospective software testers by determining whether a user login is needed and having applicant login if needed, presenting applicants with a qualifying questionnaire, determining whether the applicant qualifies to be a software tester by comparing applicant data to previously entered testing requirements, redirecting non-qualified applicants to another web page, authenticating qualified applicant login credentials, assigning applicants a role in the software test process, presenting applicants with an applicant survey if needed and accepting users responses to the applicant survey, presenting applicants with a user agreement if needed, and saving applicant data into a database.

Additionally, a system for providing customer feedback interaction and customer service interaction is disclosed. This system may include a server with one or more client selectable software modules, which provide various functions for collecting customer feedback, each module capable of being independently enabled or disabled, a client platform including a user interface allowing end users access to the Customer Feedback functionality provided by the modules. The server may maintain only the client modules, or may also maintain the user interface. The server may also include an URL Scan module, a read-only database cache, a Virtual File System, a string localization module, or a user selectable module capable of automating the process of registering software beta testers.

### BRIEF DESCRIPTION OF DRAWINGS

The disclosure will provide details in-the following description of preferred embodiments with reference to the following figures wherein:

FIG. 1 is a flow diagram showing a general view of a system employing a customer feedback center.

FIG. 2 is a flow diagram showing a detailed view of a customer feedback center.

FIG. 3 is a flow diagram showing a detailed view of an URL scan module process.

FIG. 4 is a flow diagram showing a detailed view of a database cache process.

FIG. 5 is a flow diagram showing a detailed view of a string localization module process.

FIG. 6 is a flow diagram showing a detailed view of a virtual file system process.

FIG. 7 is a flow diagram showing a-detailed view of an evaluator auto-recruitment process.

FIG. 8 is a flow diagram showing a view of the process for creating and setting up a Customer Feedback Center.

FIG. 9 is a flow diagram showing a detailed view of the process for handling Customer Feedback Center user interaction.

### DETAILED DESCRIPTION OF PROFFERED EMBODIMENTS

Embodiments of the present invention allow businesses to employ a system of gathering customer feedback and providing high-quality customer service using a computer transmission medium. In a particularly useful embodiment, the Customer Feedback System resides on a web server and is used to solicit customer feedback and provide customer support and other information to a business's customers via the Internet. In this useful embodiment, the Customer Feedback System has multiple independent modules for providing various aspects of customer relations as well as robust support for security, customizability, existing systems integration and optimal performance.

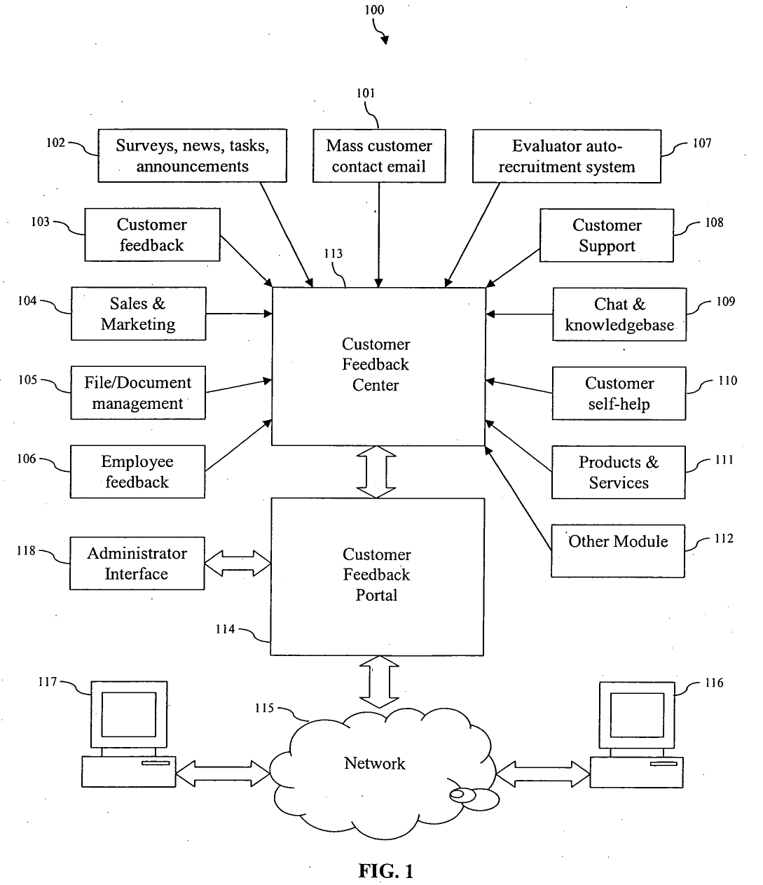

It should be understood that the elements shown in FIGS. 1-7 may be implemented in various forms of hardware, software or combinations thereof. Preferably, these elements are implemented in software on one or more appropriately programmed general-purpose digital computers having a processor and memory and input/output interfaces.

In one preferred embodiment, the present invention is implemented in software. The present invention can be, but is not limited to being, embedded in firmware, resident on microcomputer, microcode, etc. Other embodiments may be entirely hardware, entirely software, or a combination of hardware and software elements.

Additionally, the present invention can be in the form of a software product stored or accessible from any computer usable medium providing computer program code. This includes, but is not limited to any apparatus that may store, communicate, or propagate the program for use by or in connection with, any device capable of program execution. The medium may be optical, electronic, magnetic, electromagnetic, a transmission medium, or a semiconductor medium. A computer readable media may be embodied as a computer hard drive, removable computer disk, random access memory, read only memory, semiconductor or solid state memory device, magnetic tape, punch card, or optical disk. Current examples of optical disks include Compact Discs (CDs), Digital Video Discs (DVDs), High Definition DVDs (HD-DVDs), Laserdiscs, Blu-Ray Discs, Minidiscs, or magneto-optical discs. With the exception of Laserdiscs, all of these disks may be in a fixed read only memory (ROM), recordable (±R), or recordable/rewriteable (-RW) format.

A data processing system may be comprised of one or more processors with supporting electronic devices such as a motherboard. These processors may include memory resident on the processor or connected via a system bus to local memory, cache memory, or shared system or network memory. The data processing system may be coupled to input devices such as keyboards or mice, output devices such as displays or printers, and communications adapters such as network cards, modems, or networking backplanes.

Network adapters that may be included in a data processing system allow data to be transferred across an intervening public or private network to and from other terminals, servers, printers, or remote storage devices. Some current examples of network adapters are Ethernet adapters, wireless WiFi and WiMax adapters, token ring adapters, etc. Current networks include Local Area Networks (LANs), Wide Area Networks (WANs), the Internet, ad hoc networks, direct connect networks or virtual private networks (VPNs).

Electronic documents may be comprised of stand-alone electronic documents in an electronically recognizable format. This may include HTML files, rich text files, ASCII text files, binary data files, or files stored in proprietary formats. These documents may be stored in whole or in part within electronic databases or in standard computer directory structures. Electronic databases may include relational databases, fixed record format database, and non-relational databases. The most popular relational databases currently use the Structured Query Language (SQL). Fixed record databases generally use fixed size records stored in a flat file.

In the present invention, users are individuals who access the Customer Feedback System to request or submit information. Clients are entities or individuals on whose behalf the Customer Feedback Center is run. Administrators are individuals who have access rights to manage, setup, and maintain the Customer Feedback Center.

Referring now to the drawings in which like numerals represent the same or similar elements and initially to FIG. 1, a Customer Feedback System 100 is comprised of a Customer Feedback Center 113 and a plurality of User Modules 101-112. The Customer Feedback Center 113 acts as a central interaction management portal for marketing, feedback and support. In one embodiment, the Customer Feedback Center 113 acts as a repository for modules that allow publication of data to customers or customer and employee interaction. The Customer Feedback Center 113 takes in requests for data, determines which module is required to fulfill the data request, and then routes the request to the appropriate module.

The Customer Feedback Center 113 may also allow administrators to enable or disable each User Module 101-112 individually through an Administration Interface 117. For example, a business may desire a Customer Feedback Module 103 on their website, but may have no need for an Employee Feedback Module 106. Clients may be charged a set fee for the maintenance of the entire Customer Feedback Center, or on a per-piece basis for each individual Client Module enabled. An administrator may access the Customer Feedback Center though an Administrator Interface 117 for example, to enable or disable client modules individually, or in groups, run reports, modify display elements, or any perform any other administrative task. This Administrator Interface 117 may be a web-based interface, a standalone application, or any other software module known in the art.

In this example, an administrator could disable the Employee Feedback Center 106 while leaving the Customer Feedback Module enabled.

In other useful embodiments, the Customer Feedback Center 113 may allow an administrator to control all aspects of the Customer Feedback Center security and access administration.

The Customer Feedback Center 113 may also allow administrators to apply a unified design to an entire website. For example, the Customer Feedback Center 113 may present data from a user module in a manner consistent with the overall theme of the website.

In this embodiment, a mass email module 101, a survey/news/announcement module 102, file/document management module 105, or employee feedback module 106 may be accessible through the customer feedback center 113. Information on a company's products and services may be published through the customer feedback center 113 using a sales and marketing module 104 or a products and services module 111. Customer relations modules such as a customer feedback module 103, customer self-help module 110, chat and knowledgebase module 109 or a customer support module 108 may also be accessible through the customer feedback center 113. Additionally, any other useful functionality may be implemented in an “other module” 112.

A Customer Feedback Portal 114 acts as the user interface for the Customer Feedback Center 113. In one embodiment, the Customer Feedback Portal 114 resides on a company's web server and communicates to the Customer Feedback Center 113, which resides on a data server, via XML web service requests and responses over a communications network. In this embodiment, data is presented to the end user via HTML web pages. These HTML Web pages may be transmitted as HTML, transmitted as XML and converted to HTML via an XML style language transformation (XSLT) on the end user's computer, or transmitted in some other known or proprietary format.

Customers 117 and employees 116 make requests via a network 115 to the Customer Feedback Portal 114. In one preferred embodiment, requests are made using any HTML compliant web browser. In other useful embodiments, customers 117 and employees 116 may use a dedicated client software program application to interact with the Customer Feedback Portal 114.

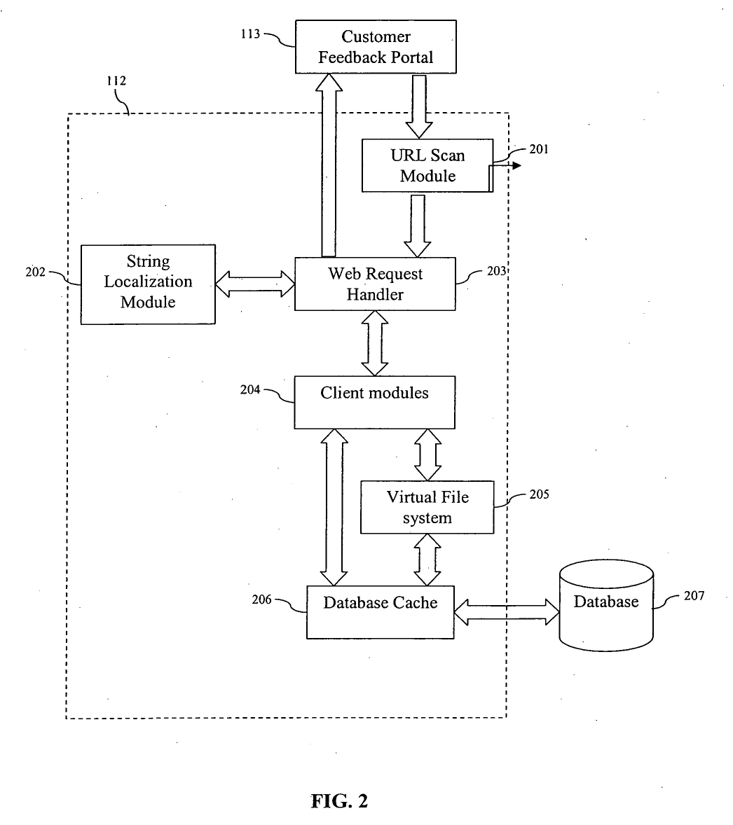

Referring to FIG. 2, a detailed diagram of a Customer Feedback Center 113 is illustratively shown. A Customer Feedback Portal 114 fields data requests from end users. In one embodiment, the Customer Feedback Portal 114 may be a series of web pages generated using any one of a number of technologies, and residing on a Web server capable of serving.HTML web pages. In other useful embodiments, the Customer Feedback Portal may include a website using static Hypertext Markup Language (HTML) web pages, or any Just-In-Time web page management tools such as traditional Active server pages (ASPs) or Hypertext Preprocessor (PHP) technology. Other embodiments may include a non-Web based interaction with end users such as an application client attached to a client-server system. Other examples of this non-Web based interaction may include a kiosk in situated in a business, or a handheld customer feedback device.

The Customer Feedback Portal 114 communicates with the Customer Feedback Center 113 by connecting to the URL Scan Module 201. The URL Scan Module 201 verifies that the incoming requests are coming from an authorized source, and is described in detail below. Once the URL Scan Module 201 has verified that the request is from an authorized source, the request is sent to the Web Request Handler 203. In one preferred embodiment, the web page requests are passed as XML web service requests. Other embodiments may use HTML POST submissions, distributed component object model (DCOM) communications, simple socket communications, or other known or proprietary network communications protocols.

The Web Request Handler 203 receives a request, and determines from the contents which client module 204 should receive the web request next. In one preferred embodiment, the Web Request Handler 203 looks at the requested method called by an XML web service request, and then instantiates the appropriate module, if needed, before calling the requested method in the module. In one embodiment, the web service application handles determining the request target, and fulfilling the web service request. In this embodiment, the client modules may include one or more of the modules 101-112 illustratively shown in FIG. 1.

For example, the Web Request Handler 203 receives all requests for a business's website. If a request to provide customer feedback is submitted to the business website, the Web Request Handler 203 would receive the request, and determine from the contents of the request that a user wished to submit customer feedback. The Web Request Handler 203 would then call the Customer Feedback Module 103 and submit relevant information from the request to the Customer Feedback Module 103. The Web Request Handler 203 would then wait for a response from the Customer Feedback Module 103 while the Customer Feedback Module 103 processed the submitted data. After receiving a response from the Customer Feedback Module 103, the Web Request Handler 203 generates an appropriate response which is then passed to the user.

Client modules 204 may make use of a virtual file system 205 to extract data from the Database Cache 206, or the client modules 204 may connect to the database cache directly. The Virtual File System 205 is discussed in greater detail below. In one embodiment, a client module 204 that displays database-stored files and folders, such as a File/Document manager 105 in FIG. 1, may connect to the Virtual File System 205 to manage user permissions and retrieve files from the database cache 206.

Other client modules 204 not needing management of file and folder user permissions may connect to the Database Cache 206 directly. The Database Cache 206 acts as a buffer for the database 207, and is discussed further below. In one embodiment, client modules such as the Chat & Knowledgebase 109, Customer Support 108, and Customer Self-Help 110, may connect to the database cache 206 to retrieve information instead of connecting to the database 207 directly.

After the Web Request Handler 203 receives data back from the appropriate Client Module 204, the Web Request Handler 203 puts the data in a format suitable for transmission back to the user.

In one embodiment, the Web Request Handler may format the data as a XML Web Service request.

The Web Request Handler then invokes the String Localization Module 202. The String Localization module 202 translates any appropriate text into a conversational language designated by the user. The String Localization Module 202 is discussed in further detail below.

In one embodiment, for example, the Web Request handler calls a client module 204, such as the Knowledgebase module 109 in FIG. 1. The Knowledgebase Module 109 in FIG. 1 collects data responding to the user's request from the Database Cache 206, and then passes it back to the Web Request Handler 203. The Web Request Handler 203 then puts the Knowledgebase data into a format for transmission to the user, then calls the String Localization Module 202 to translate any text into a language suitable for the end user. For instance, if the User had previously indicated that Spanish was their preferred language, the String Localization Module 202 would translate any applicable text into Spanish before the data was passed by the Web Request Handler back to the Customer Feedback Portal 114.

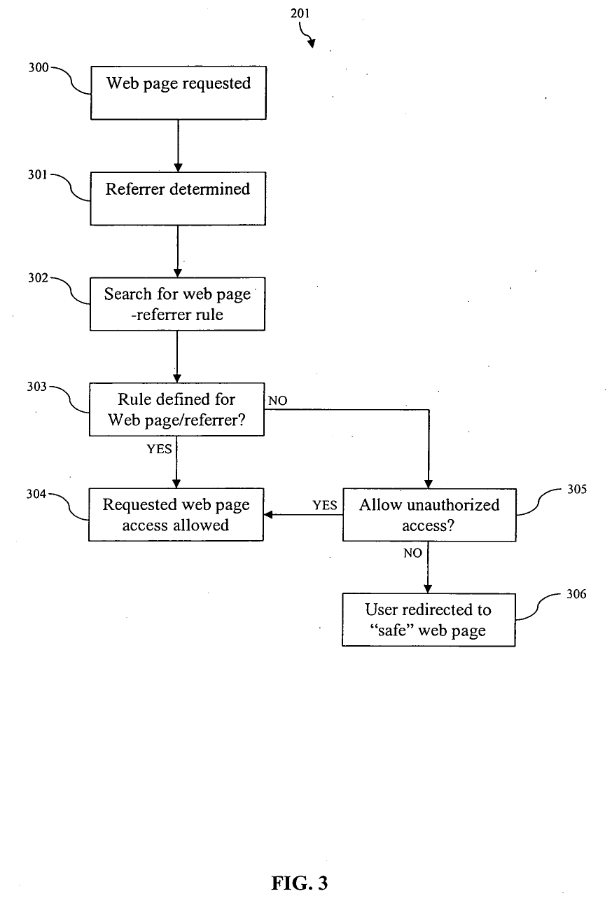

Referring to FIG. 3, a logic flow diagram for an URL Scan Module 201 is illustratively shown. In block 300, a web page is requested from the web server. In one embodiment, the request may be initially fielded by the Customer Feedback Center 113 shown in FIG. 1, then passed through the URL scan module 201.

After receiving the request for a web page 300, the URL Scan Module 201 then determines the referrer 301. In this embodiment, the referrer is determined by reading the value associated with the “Referer” tag in the web page request header. Generally, this referrer value is an URL indicating the page the requester made the web page request from. Once the referrer is determined 301, the URL Scan Module 201 then searches for a rule defined for the web page/referrer combination 302. In this embodiment, the rules may be defined in a configuration file such as an XML configuration file, e.g. a config file. In other useful embodiments, these rules may defined in an .ini file, a data base, within the module code, a proprietary file format, or in some other useful file format.

If a rule is defined for the web page/referrer combination 303, the URL Scan Module 201 then allows the server to present the requested page to the user 304.

However, if a rule is not defined for the web page/referrer combination 303, the URL Scan Module 201 considers the request “unauthorized”. The module then determines whether a rule is defined for unauthorized redirects 305. In this embodiment, if an unauthorized redirect rule is defined 304, any unauthorized request, or request without a rule defined for the web page/referrer combination, then the URL Scan Module 201 forces the server to redirect the user to a “safe” page defined in the rule 306. If no unauthorized redirect rule is defined 305, then the page is considered unsecured, and the server is allowed to transmit the requested page to the user 304.

For example, in the one embodiment, a rule may be defined in an XML tree similar to the following:

<UrlScan unauthorizedRedirect=“http://www.domain.com/login”>

<rules>

<rule>

<urlPattern><![CDATA[http://some-domain.com*]]></urlPattern>
<destination>MyDocs.aspx</destination>

</rule>
<rule>

<urlPattern><![CDATA[http://another-domain.com*]]></urlPattern>
<destination>KnowledgeBase.aspx</destination>

</rule>

</rules>

</UrlScan>

In this embodiment, the URL Scan Module 201 would search the XML tree for a rule defining both the requested web page URL and the referrer URL. In this example a request for the “KnowledgeBase.aspx” web page referred from www.another-domain.com would be considered a rule match, and the request would be allowed. Had this request come from www.malicious-domain.com, the URL Scan Module 201 would have found no matching rule, and the access would be unauthorized.

In one preferred embodiment, wildcards may be used to allow an administrator to define entire domains that are allowed, instead of having to modify the rule set every time an allowable referrer page is added to a trusted site. In this embodiment, the wildcard takes the form of an asterisk (*), denoting that any number of characters found in place of the wildcard satisfy the rule. Using the example above, “http://another-domain.com*” would allow a referrer from any page within the another-domain.com website such as http://another-domain.com/home.html or http://another-domain.com/images/imagel.png. In other particularly useful embodiments, this URL pattern wildcard may use a single character wildcard such as question mark (?), or SQL-type wildcards such as percent (%) or underscore (_). Yet other particularly useful embodiments may use regular expressions as the URL pattern for matching referrers in the URL scan module rules.

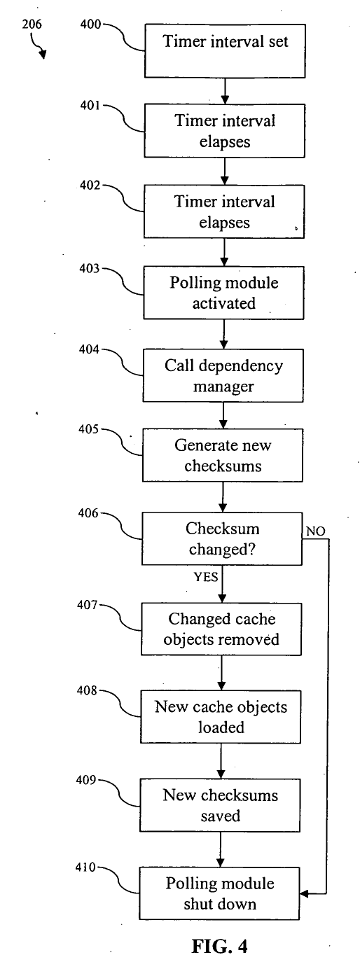

Referring now to FIG. 4, a logic flow diagram for a Database Cache 206 is illustratively shown. A timer is set with an initial interval value for polling a database for changes 400. In one preferred embodiment, the timer interval is generally set for 500 milliseconds, but may be changed depending on factors that include web server or database load. In other useful embodiments, the cache may be loaded immediately upon Database Cache startup, then refreshed at specified intervals.

After setting the timer interval in block w00, the timer is started in block 401. When the interval has elapsed 402, a polling module is activated in block 403. The polling module is intended to control the refreshing of the database cache. Once activated in block 403, the polling module calls the database dependency manager in block 404 and communicates the need to refresh the database cache. In one embodiment, the database cache may include the most up to date results of a computationally complex query such as an OUTER JOIN or a full table scan query generated by using a WHERE IN clause.

The polling module then has the database cache dependency manager generate new checksums for every table in the database that has an associated dependent object 405. In one preferred embodiment, the checksum is generated by the database. In other embodiments, the checksum may be generated by the dependency manager, or a third component. Checksums can be generated using any formula that gives a satisfactory opportunity to avoid collisions, or checksums for different table values being equal. Current examples of checksum formulas include simple sum, MD5, SHA-1 and Cyclic Redundancy Checks (CRCs), which are known in the art.

The polling module then compares the new checksums to previously generated checksums 406. In this embodiment, the previously generated checksums may be from the previous cache request, or if no previous cache refreshes have occurred, the initial checksum values computed when the database cache was executed.

If no checksums have changed, that is, if the values of the old and new checksums are equal, the polling module is shut down 410. However, if one or more of the new checksums differs from the old checksums, any objects dependent on the changed table are removed from the database cache dependency manager 407. New dependent objects are then generated to replace the previously removed objects 408, and the new checksums are saved into the polling module 409. The polling module then shuts down 410 until the timer interval elapses again in block 402 to refresh the cache, wherein the process repeats

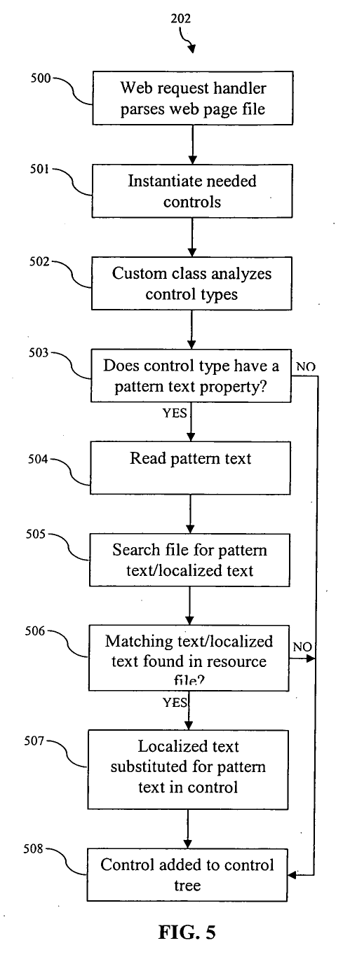

Referring to FIG. 5, a logic flow diagram for an automated String Localization Module 202 is illustratively shown. In the string localization process, a Web Request Handler 203 receives a request for a web page, then loads and parses the appropriate file in block 500. In one embodiment, a web service application is called by the web server, and is passed the appropriate web service request. The web service application then loads the requested file, parsing the file to create any server-side controls or run executable scripts.

The Web request handler then instantiates each needed control in block 501. A custom class analyzes the control type 502 to determine if any of the instantiated controls needed by the web page for text properties with replaceable text 503. In this embodiment, a custom ASP.Net class is used, wherein the class searches for textual properties with a “<$ . . . >” pattern. For example, a requested web page may include the following code:

<div class=“container”>

<h3><$ CFC.Web.MySettings ></h3>
<p><$ CFC.Web.Administration ></p>
<p>asp:DropDownList runat=“server” id=“drpCategories” /></p>

</div>

In the above listed code, the custom class would find both CFC.Web.MySettings and CFC.Web.Administration, and would attempt to replace these patterns with localized text.

If the control is found to have a pattern text property, the String Localization Module 202 then reads the pattern text in block 504, then searches a resource file for the pattern text and an associated localized value 505. In one embodiment, resource files are generated prior to module deployment. These resource files may be separated based on language. An example of the contents of an English resource file may look like the following:

<?xml version=“1.0” encoding=“utf-8”?>
<root xmlns=“http://tempuri.org/CFC.Web.xsd”>

<data name=“CFG.Web.MySettings”>

<value>My settings</value>

</data>
<data name=“CFC.Web.Administration”>

<value>Administration</value>

</data>

</root>

The Localization module then determines in block 506 if the pattern text and associated localized text exists in the resource file. If matching text is found in the resource file by the localization module, then the associated localized text representation is substituted for the pattern text in the control 507. Referring to the previous example, in this embodiment, after finding the pattern text entries “CFC.Web.MySettings” and “CFC.Web.Administration” in the web page file, the custom class would compare those pattern text entries to entries in the localized resource file. Upon finding both, the custom class would replace the pattern text entries with the text “My Settings” and “Administration” to generate the following code:

<div class=“container”>

<h3>My Settings</h3>
<p>Administration</p>
<p>asp:DropDownList runat=“server” id=“drpCategories” /></p>

</div>

After any pattern text in any applicable controls has been replaced, or if no pattern text property exists in a control, the control is added to the control tree 508 for normal use by the web request handler.

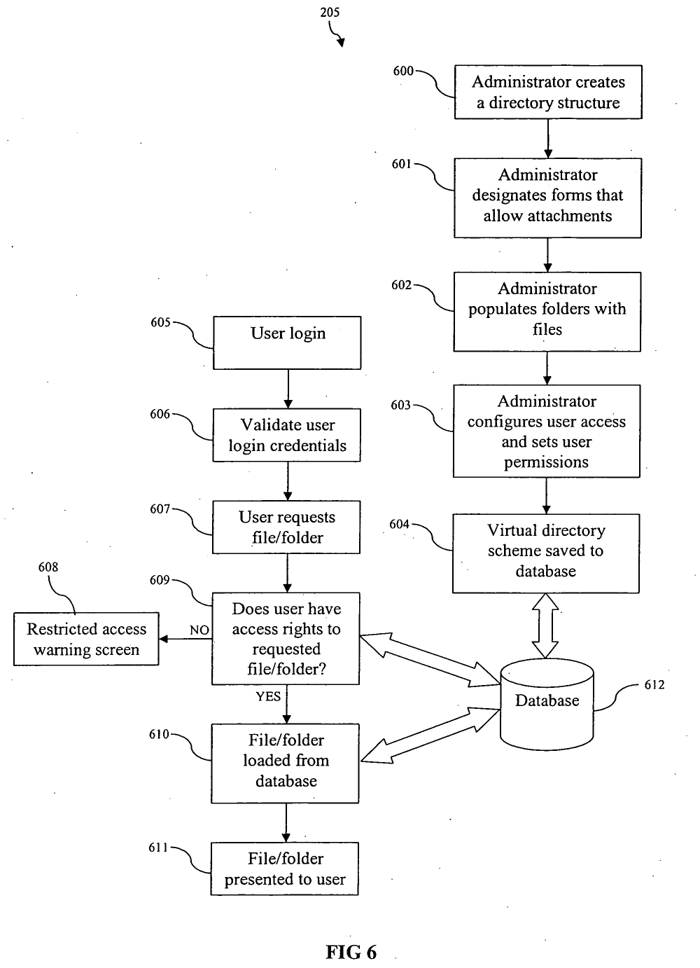

FIG. 6 illustrates a logic flow diagram for a Virtual File Management System 205. Any of the steps for configuring the Virtual File Management System 205 may be completed manually, through an automated process, or a combination of both manual and automated means.

An administrator who wishes to allow a user access via a network to files residing on a database-would first create a directory structure 600. In one embodiment, the directory structure and any files included in it are accessible via a web browser over the Internet. In this embodiment, the directory structure is a tree structure having a root directory labeled “My Documents”. The directory may also have a directory labeled “User Uploads” for storing file attachments uploaded by the user via web forms.

After the administrator has created a directory structure 600, the administrator designates which web forms users are allowed to submit attachments through 601. The administrator then populates the folder structure with files 602 and configures user access to the files and folders 603. In one embodiment, an administrator may separate documents into folders based on the subject matter, or base on their level of sensitivity. The administrator may then configure user access to only allow senior managers to access the most sensitive documents. In other particularly useful embodiments, junior members of distinct work groups may be given access to relevant documents, while more senior members or managers of a distinct workgroup may be allowed to view documents for other groups.

After the administrator has finished configuring the virtual directories, documents and user access, the Virtual File Management scheme 604 is saved to a database 611. In one embodiment, each individual step of the configuration may be saved temporarily or permanently to a database or temporary file to avoid losing any completed work should an error occur.

When a user desires to access a file that has been made available through the Virtual File System, the user would first login 605. In one embodiment, the user would login with a username and password through a portal web page, preferably through a Secure Socket Layer (SSL) connection. The users credentials would then be validated in block 606 against registered users in the database 612.

The user would then request a file or folder 607. The Virtual File Management System 205 would then query the database 612 to determine whether the user has rights to access the requested file or folder. In this embodiment, a logged in user would have their access rights to a file or folder verified against the rights granted by the administrator during configuration 603.

If a user does not possess sufficient rights to access the requested file or folder, the user would be presented with a warning screen 608 advising the user that the user is not authorized to access the resource. However, if the user does have sufficient access rights to view the requested file or folder, the requested file or folder is loaded 610 from the database 612, and then transmitted to the user to view or save 611. In this embodiment, a user that does not possess sufficient rights would be presented with a warning screen, but may also have their Internet Protocol address (IP address) logged, along with the name or location of the file the user attempted to access. Additionally, any other request, whether failed or successful, may be logged into the database 612 for statistical purposes. In some embodiments, this log file may be used to determine when a malicious attempt at access had occurred, or to determine which documents users accessed most frequently.

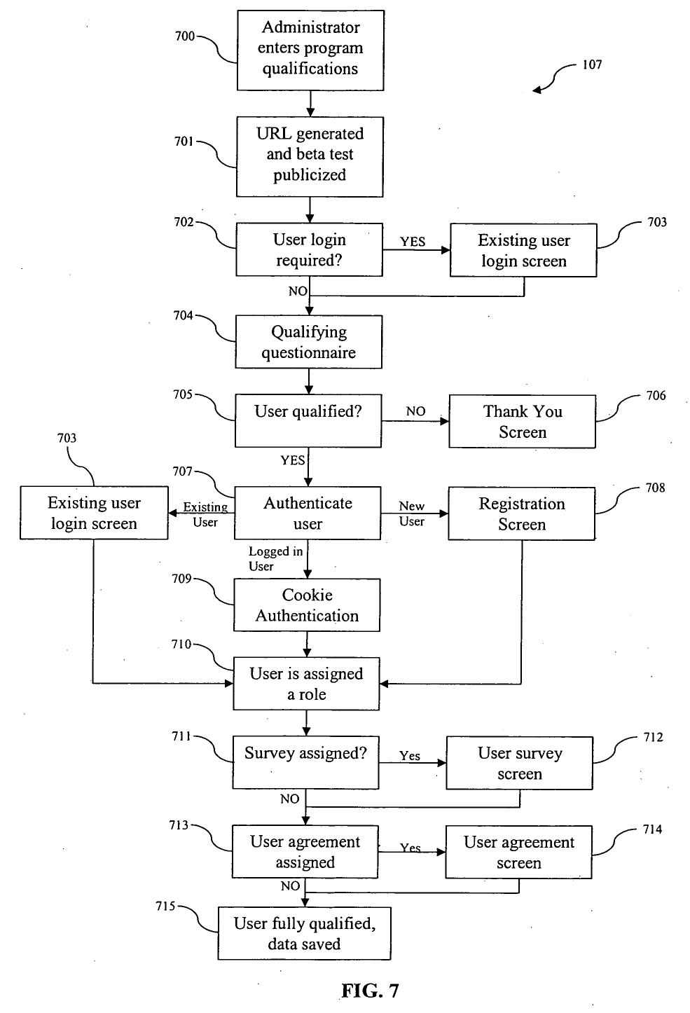

FIG. 7 illustrates a logic flow diagram for an Evaluation Auto-Recruitment Module 107. In this module, users may sign up to receive nearly completed software programs in exchange for reporting bug and other issues before the software is released to the general public. This early testing is commonly referred to as “beta testing”.

A system administrator first enters qualifications and information for a new program evaluation regimen 700. In one embodiment, qualifications may be comprised of questions asked of potential evaluators, and associated answers that would render an evaluation candidate acceptable or not. Other information entered by the system administrator may also include the name of the program to be evaluated, a description of the program, messages to be displayed to potential evaluators that do qualify, do not qualify, or fail to meet some other specified criteria such as enrollment date. Additionally, in this embodiment, the administrator may enter parameters such as the maximum number of evaluators accepted, the starting or ending dates of the enrollment period, user role assignments for evaluators, or a survey for evaluators to complete.

Once the administrator has entered the testing program qualifications 700, a hyperlink is generated for use in publicizing the beta test 701. In this embodiment, the hyperlink may be placed in an email which is then sent to customers inviting them to participate, or placed on a web page to allow user to click through to sign up for the beta test.

Once a user has clicked on the link for the beta test signup, the user may be asked to login using an existing website account 702. In this embodiment, the administrator has the option of requiring users to login to the website before proceeding to sign up for the beta test. The login requirement may be used to prevent non-customers from signing up for the beta test, or to allow administrators to gather more data regarding those signing up.

Once a user has logged in 702 if needed, users are then asked to answer a set of qualifying questions 703.entered previously by the administrator 700. In this embodiment, the questions may be used to determine, among other things, whether the beta testing applicant's computer hardware meets minimum specifications, that the applicant possesses adequate skills to properly evaluate the software, or to provide the company with accurate statistical data regarding the applicant.

The answers given by the applicant for the qualifying questions are then validated 704 against the desired responses previously entered by the test administrator 700. In one embodiment, the beta test administrator may desire that each applicant match all of the desired answers before being considered qualified to participate in the beta test. In other embodiments, applicants may be required to give the desired answers in a set percentage or number of questions.

If a user fails to meet the threshold of correct answers 705, the user is considered to not qualify for the beta test. In this embodiment, non-qualifying users may be directed to an exit page thanking them for their participation, and then redirected to another page.

Upon meeting the threshold of the qualification questionnaire, the user is then authenticated and logged into the system 706. Users that had previously logged on through the login screen 702 are authenticated via a cookie stored on their computer 709. Users that were not required to login prior to the qualifying questionnaire 703, but that have an existing account with the test provider will be asked to login 706. Users without a current account are directed to a registration screen 708.

Following user authentication 707, a user is assigned a role 710 in the beta testing process. In this embodiment, user roles have previously been defined by the administrator 701. In one embodiment, each user may be assigned a role which limits the features of the software the user can access. This lets the test administrator focus on specific parts of the application for more extensive testing. In other useful embodiments, users may be assigned different levels of authority to simulate administrator-user scenarios.

After users are assigned roles 710, users may be asked to take a survey 711. The assignment of a survey would have been defined previously by the test administrator 701. If a user survey had been previously assigned, the user would be presented with the survey screen 712. The survey may be used to gather statistical data regarding users, or in other embodiments, may be used to correlate beta test results with defined user groups.

Next a determination of whether a user agreement has been assigned is made 713. If a user agreement was previously assigned by the test administrator 701, the user is presented with a user agreement screen 714. In this embodiment, the user agreement may be an End User License Agreement (EULA), or may contain additional restrictions or licensing terms specific to the beta test being administered.

After the user agreement stage 713-714, the user is considered fully qualified 715, and their data is saved into an appropriate database. In this embodiment, users contact information may be used to notify the user where the user may download the application to be tested.

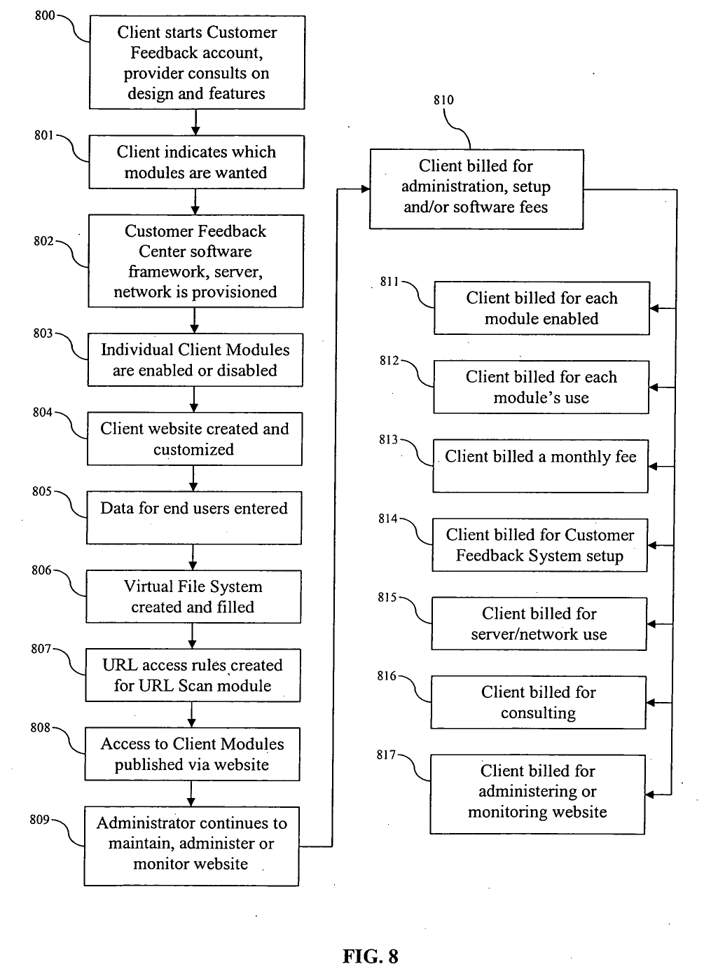

FIG. 8 illustrates a logic flow diagram that exemplifies, installing a Customer Feedback Center. A Client who desires a Customer Feedback Center contacts a Customer Feedback Center provider. The provider then creates an account for the Client in block 800. The Client would then indicate in block 801 which Client Modules the Client would like to employ to gather feedback from customers.

For instance, a restaurant chain may be likely to have surveys about the customer experience on their Customer Feedback Center website. In addition, the restaurant chain may wish to directly solicit customer feedback through a Customer Feedback Module, have the ability to provide nutritional information through a Products and Services Module, or announce new menu offerings and promotions through a Sales and Marketing Module.

A different example may be a computer sales corporation that wishes to provide its customers with a way to submit feedback, get technical support, and receive information on upgrades and product promotions. In order to provide a way for customers to express their views on the sales and service of the computer sales company, the company may select a Customer Feedback Module for their Customer Feedback Center. Additionally, this computer sales company may select Client Modules such as a Customer Support Module, a Chat and KnowledgeBase Module, and a Customer Self-Help Module to provide customer technical support. The computer sales company may also select a Products and Services Module or a Surveys, News and Announcements Module to spread the word to customers about any upgrades or product promotions.

The Customer Feedback Center service provider would then provision the Customer Feedback Center in block 802, setting up an environment for the Customer Feedback Center software to run. In some cases, this may include providing, possibly for an additional fee, a computer server and Internet or network connectivity for the client company. The provider would then implement the client's Customer Feedback Center plans, enabling or disabling modules to suit the client's needs.

Referring to the above example of a restaurant chain client, the client may wish to have their entire Customer Feedback Center managed and hosted by a provider. In such a case, the provider may allocate a server dedicated to the restaurant chain's Customer Feedback Center. The provider may also use a shared hosting arrangement where the restaurant chain client's Customer Feedback Center resides on a server with other Customer Feedback Centers in order to reduce costs.

In the example of the computer sales company cited above, the client may wish to have their Customer Feedback Center hosted on equipment belonging to the client. In such an instance, the client would set up a computer server with network connectivity at the client's data center, providing access to the provider for administration of the Customer Feedback Center.

In the examples of both the restaurant chain and the computer sales company, the Customer Feedback Center provider would then install the software necessary to run the Customer Feedback Center on the appropriate server.

For the restaurant chain, the provider would then enable the Customer Feedback Module, Products and Services Module, and Sales and Marketing Module.

In the example of the computer sales company, the provider would enable the previously selected Customer Feedback Module, Customer Support Module, Chat and KnowledgeBase Module, Customer Self-Help Module, a Products and Services Module and Surveys, News and Announcements Module.

Selectively enabling modules allows the provider to bill the client only for the services actually used, i.e. billing only for the modules that have been enabled. A provider may also wish to bill a client for a group of modules, or offer a fixed or reduced rate for using multiple modules. Additionally, the Customer Feedback Center provider may charge a flat monthly or yearly fee for the use and management of various Customer Feedback Center modules, or may bill based on network traffic, number of successful transactions, or some other quantifiable metric of actual Customer Feedback Center use.

After Client Modules are enable or disabled in block 803, the provider then creates a website around the Customer Feedback Center in block 804. This website would ideally allow customers of the client to access information from and submit information to the Client Modules. Additionally, a client may have the Customer Feedback System provider create an interface with a unified theme for presenting data to customers.

For instance, referring back to the restaurant chain example from above, the restaurant chain client may have an existing website, and may want to integrate the Customer Feedback Center into the existing website. The provider would then create web pages using the same colors, layout and theme as the existing restaurant website. The customer would then be able to place hyperlinks on the exiting webpage to the new Customer Feedback Center web pages.

For a computer sales company, the provider may create a completely new website separate from the client's existing online sales website. In this case, the provider may design a website different from the client's existing website, and may include a entry page with links to web pages that access the various Client Modules.

After creating a website for accessing the various client modules in block 804, the provider would then enter data to be presented to the end users in block 805. This may be creating customer surveys, entering data into a database for lookup by customers such as in a knowledgebase, or it could be creating static web pages for announcements such as new product offerings and photographs of new products.

For a restaurant chain, entering data for users may include creating a survey regarding the service a customer received at one of the chain's restaurants, or about how customers felt about a newly introduced meal. The restaurant chain may also have the Customer Feedback System provider enter other data regarding the business, for instance material containing the nutritional content of the restaurants' menu items or promotional material regarding an updated menu or new menu offerings.

Entering data for end users for a computer sales company could entail entering into the Knowledgebase common issues that customers have experienced with computers they purchased from the client, and the resolution to those problems. Additionally, the provider may enter data into the Customer Self-Help module that would allow a customer to diagnose problems with their computer.

If any Client Modules need access to the Virtual File System, the provider would then create the directory structure and fill the Virtual File System with documents in block 806.

Using the example of a restaurant chain again, instructions on how to view reports on customer surveys and feedback may be posted in the Virtual File System and access to the reports limited to managers of the company. Alternatively, for a computer sales company, reports on the most frequently asked questions or most commonly reported problems may be posted to the Virtual File System for perusal by executives.

The provider may next define URL access rules for use by the URL Scan Module in block 807. In the case of the restaurant chain, the client may wish to limit access to the Customer Feedback System to users who access the Customer Feedback System from the company's existing website. This may allow the client to have customers first view any disclaimers, advertisements or other promotional materials before submitting feedback.

In the case of a computer sales company, URL Scan rules may be defined to direct customers to the Knowledgebase of Customer Self-Help Modules before contacting the company directly for help.

The web pages with access to the Customer Feedback System would then be published for use by the relevant users in block 808. In the case of a restaurant chain using a website to gather customer feedback, this would include adding to an appropriate web page hyperlinks leading to the Customer Feedback System web pages.

The Administrator may then continue to maintain, administer or monitor the website in block 809. This may include, but is not limited to updating web pages, creating new customer surveys, creating reports, assuring that the website and network are running properly, or adding and removing new modules and features as requested by the client.

The Client would then be billed in block 810 for the administration, setup and software fees. The billing for may include billing for each module enabled as in block 811, each module's actual usage as in block 812, a flat monthly fee as in block 813, fees for the initial setup and consulting as in blocks 814 and 816 respectively, fees for network lease or sale as in block 815, or fees for administering or monitoring the Customer Feedback System website as in block 817.

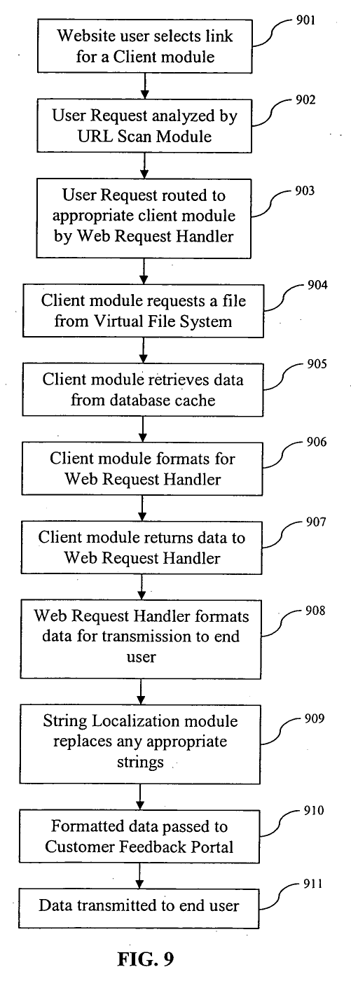

Referring now to FIG. 9, a block-flow diagram of a user's interaction with the Customer Feedback System is illustratively shown. In this process, a user or customer first selects a link in block 901 to request information from, or submit information to, a Client Module.

Referring back to the previous restaurant chain example, a user may click a link to request a blank user survey regarding customer satisfaction at one of the chains restaurants. Alternatively, the user may click a link to submit a completed survey, or to submit a customer feedback form.

In the example of a computer sales company, a customer may also submit a completed customer feedback form or a search for software upgrades. A customer may also request information on known problems and the corresponding fix for a computer the customer has previously purchased from the client.

After the user request is submitted in block 901, the URL Scan module verifies the referring web page in block 902, and if the request is allowed, sends the request to the Web Request Handler. The Web Request Handler determines from the contents of the request which Client Module would be appropriate for handling the user request in block 903.

For example, a request to submit a completed customer feedback form would be sent to the Customer Feedback Module. In another example, a request for a document from the Virtual File System would be sent to the File/Document Management Module.

The appropriate Client Module would then handle processing the data sent in the request. A request for a document from the Virtual File System would cause the File/Document management module to retrieve the requested document from the File/Document Management Module in block 904.

Any module needing to retrieve data from database storage would then access the Database Cache to access the requested data in block 905. Referring to the above restaurant chain example, a customer who had submitted a request for a blank Customer Feedback form would have his request sent by the Web Request Handler to the Customer Feedback Module. The Customer Feedback Module would retrieve the information relevant for generating the requested form from the Database Cache.

After retrieving data from the database cache in block 905, the Client Module processes the data and puts any results into a format appropriate for the Web Request Handler in block 906. In a system where the Client Modules are Web Service Applications, the response data would be formatted as a Web Service response.

For a user of the restaurant chain's Customer Feedback Center who requested a document from the File/Document Management Module, the user would have the login credentials submitted to the Module for verification that the user has access rights to the requested document. In the case of an unauthorized user, the File/Document Management Module would create a Web Service Response indicating that the user was not authorized to access the requested document. Alternatively, if the user did have access privileges to the requested document, the File/Document Management Module may create a Web Service response indicating that the user has the appropriate access privileges with the requested document attached.

The formatted data would then be transmitted to the Web Request Handler in block 907, which would integrate the Client Module data into a response for transmission to the end user in block 908. Referring to the above computer sales company example, if a user had submitted a Customer Feedback form, the submission request would be saved to the database by the Customer Feedback Module. The Customer Feedback Module may then send a response to the Web Request Handler indicating that the data was successfully saved along with a web address for an exit or a web page thanking the user for their submission. After the Web Request Handler receives confirmation that the submission was successful, the Web Request Handler would format a response to redirect the user's browser to the appropriate exit page, or create a response displaying the exit page directly.

After formatting any response data for transmission to an end user in block 908, The Web Request Handler then invokes the String Localization Module to replace any appropriate strings with an alternative language in block 909.

Using the example of the restaurant chain Customer Feedback System, a user wishing to submit feedback may prefer to view web pages in a language other than that which the web pages were originally designed in. A restaurant chain spanning many countries may have customers and employees speaking many different languages. For instance, if a Spanish speaking customer may wish to view the website in Spanish. In this case, when the Web Request Handler invokes the String Localization Module, any text in the webpage indicated as translatable by appropriate pattern text would be replaced with text in the appropriate language. For a Spanish speaker, this may mean labeling “submit” buttons with “sometase”, or setting the text of a name entry field label to “nombre” instead of “name”.

The formatted and localized text would then be passed to the Customer Feedback Portal in block 910, and then transmitted to the end user in block 911. In the case of a restaurant chain using a website to garner feedback from customers, the data would have been formatted as a web page, sent to a web server, and transmitted to the end user via the Internet.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method for installing and enabling a Customer Feedback System, the method comprising the method steps of:
providing a software framework capable of supporting a plurality of customer feedback system modules, each capable of supporting one or more features of a customer feedback system;
enabling or disabling client modules based on a selected set of client modules,
maintaining the set of client modules selected by the client;
customizing a user interface and the set of modules based upon an application of the client;
processing user requests and/or feedback data from users; and
the Customer Feedback System processing the customer data for the client.

2. The method as recited in claim 1, wherein maintaining the set of client modules further comprises:
billing the client for maintaining the client modules, wherein the billing includes one or more of:
billing the client for each module enabled;
billing the client for each use of each module;
billing the client a monthly fee;
billing the client for setting up the Customer Feedback System; and
billing the client for customization of the Customer Feedback System.

3. The method as recited in claim 1, wherein maintaining the set of client modules includes:
supplying needed network resources for hosting a customer feedback system;
administering a customer feedback system on behalf of a client;
consulting on the design and features of a customer feedback system; and
monitoring a customer feedback system on behalf of a client.

4. The method as recited in claim 1, wherein processing user requests includes restricting access to network resources using an URL Scan Module, restricting access to network resources comprising the method steps of:
determining the referring network resource;
searching for a rules defined defining access rights for the referring network resource and the requested network resource; and
allowing access to the requested network resource if a rule is defined for the referring network resource and the requested network resource

5. The method as recited in claim 4, restricting access to network resources further comprising the method steps of:
allowing access to the requested network resource if users are allowed unauthorized access; and
redirecting users to an alternate network resource if users are not allowed unauthorized access and if a rule is not defined for the referring network resource and the requested network resource.

6. The method as recited in claim 1, wherein processing user response data includes using a string localization module to format selected fields of response data into a selected language, wherein formatting selected fields includes a method for locating and replacing selected fields, the method steps comprising:
parsing response data;
instantiating needed controls;
using a custom class to analyze each control type for a predefined text pattern;
reading text found inside the predetermined text pattern;
searching a file for text matches and associated localized text;
replacing a predetermined text pattern in the control with the associated localized text; and
adding control to a control tree.

7. The method as recited in claim 6, wherein the file is a resource file including text patterns and further comprising the step of associating text strings with the text patterns, the text strings being presented in one or more languages, the language of the text strings being determined by the user.

8. The method as recited in claim 1, wherein processing user requests includes caching database information, the user modules retrieving data from a database cache, the method of caching database information comprising the methods steps:
setting a timer interval;
starting the timer;
upon the timer interval elapsing, activating a polling module;
the polling module calling a database dependency manager;
the database dependency manager determining which database objects are needed to update the database cache;
causing checksums to be generated for each needed database object;
comparing the newly generated checksums with previously stored checksums;
loading into the cache from the database any database objects for which the newly generated checksums and previously stored differ;
saving the most current checksums; and
shutting down the polling module.

9. The method as recited in claim 1, wherein processing user requests in user modules includes providing data regarding files and folders through a virtual file system, one or more user modules retrieving data from the virtual file system, the method of retrieving data from the virtual file system comprising the methods steps:
setting permissions for a user to access specified files and folders;
receiving a user's login credentials;
validating the user's login credentials;
receiving a request from the user for a file/folder;
restricting access to a requested file/folder based on previously set permissions associated with the user's credentials;
redirecting a user to second network resource if the user's credentials do not have the appropriate permissions to access a file/folder;
granting access to a requested file/folder based on previously set permissions associated with the user's credentials;
loading a requested file/folder from a database for a user granted the appropriate permissions to access the requested file/folder; and
transmitting the requested file/folder to a user granted the appropriate permissions to access the file/folder.

10. The method as recited in claim 9, wherein setting permissions for a user to access specified files and folders includes a method comprising the method steps:
a system administrator creating a directory structure for the storage of files and folders;
a system administrator designating network resources allowed to submit data to the network;
a system administrator populating the directory structure with files and folders;
a system administrator configuring permissions identifying which network resources a user may access; and
a system administrator saving the directory structure, directory structure contents, and user permissions to a database.

11. The method as recited in claim 1, wherein providing a selection of distinct user modules includes providing access to a module implementing a method for registering software beta testers, the method comprising the method steps:
an administrator specifying software testing program qualifications and requirements;
generating a Uniform Resource Locator (URL) indicating an Internet address where users may register to become software testers;
determining from the previously entered test requirements whether user login is needed;
having applicants login if login is needed;
presenting applicants with a qualifying questionnaire;
accepting applicant data in response to qualifying questionnaire;
determining whether applicant qualifies to be a software tester by comparing applicant data to previously entered testing requirements;
redirecting non-qualified applicants to a second network resource;
authenticating qualified applicants login credentials;
assigning applicants a role in the software test process;
presenting applicants with an applicant survey, if needed by the previously entered test requirements;
accepting-user data in response to any needed applicant survey;
presenting applicants with a user agreement, if needed by the previously entered test requirements; and
saving applicant data into a database.

12. A method for installing and enabling a Customer Feedback System, the method comprising the method steps of:
providing a software framework capable of supporting a plurality of customer feedback system modules, each capable of supporting one or more features of a customer feedback system;
enabling or disabling client modules based on a selected set of client modules,
maintaining the set of client modules selected by the client;
customizing a user interface and the set of modules based upon an application of the client;
presenting data from a plurality of client modules in a uniform fashion;
localizing data presented to users into a plurality of languages; and
restricting access to network resources based on the referring network resource;
enhancing data retrieval speeds experienced by a client module by caching database information; and
providing client modules with access to a file system stored in a database.

13. The method as recited in claim 12, localizing data includes using a string localization module to format selected fields of response data into a selected language, wherein formatting selected fields includes a method for locating and replacing selected fields, the method steps comprising:
parsing response data;
instantiating needed controls;
using a custom class to analyze each control type for a predefined text pattern;
reading text found inside the predetermined text pattern;
searching a file for text matches and associated localized text;
replacing a predetermined text pattern in the control with the associated localized text; and
adding control to a control tree.

14. The method as recited in claim 12, wherein restricting access to network resources includes using an URL Scan Module, restricting access to network resources further comprising the method steps of:
determining the referring network resource;
searching for a rules defined defining access rights for the referring network resource and the requested network resource; and
allowing access to the requested network resource if a rule is defined for the referring network resource and the requested network resource.

15. The method as recited in claim 14, wherein restricting access to network resources further comprises the method steps of:
allowing access to the requested network resource if users are allowed unauthorized access; and
redirecting users to an alternate network resource if users are not allowed unauthorized access and if a rule is not defined for the referring network resource and the requested network resource.

16. The method as recited in claim 12, wherein enhancing data retrieval speeds includes caching database information, the user modules retrieving data from a database cache, the method of caching database information comprising the methods steps:
setting a timer interval;
starting the timer;
activating a polling module upon the timer interval elapsing;
the polling module calling a database dependency manager;
determining through the database dependency manager which database objects are needed to update the database cache;
generating checksums for each needed database object;
comparing the newly generated checksums with previously stored checksums;
loading into the cache from the database any database objects for which the newly generated checksums and previously stored differ;
saving the most current checksums; and
shutting down the polling module.

17. The method as recited in claim 12, wherein providing client modules with access to a file system stored in a database includes providing data regarding files and folders through a virtual file system, one or more user modules retrieving data from the virtual file system, the method of storing and retrieving data from the virtual file system comprising the methods steps:
creating a directory structure for the storage of files and folders;
designating network resources allowed to submit data to the network;
populating the directory structure with files and folders;
configuring permissions identifying which network resources a user may access; and
saving the directory structure, directory structure contents, and user permissions to a database receiving a user's login credentials;
validating the user's login credentials;
receiving a request from the user for a file/folder;
restricting access to a requested file/folder based on previously set permissions associated with the user's credentials;
redirecting a user to second network resource if the user's credentials do not have the appropriate permissions to access a file/folder;
granting access to a requested file/folder based on previously set permissions associated with the user's credentials;
loading a requested file/folder from a database for a user granted the appropriate permissions to access the requested file/folder; and
transmitting the requested file/folder to a user granted the appropriate permissions to access the file/folder.

18. A system for providing customer feedback and customer interaction, the system comprising:
a server including a plurality of client selectable modules, each module providing a different customer feedback function, the modules being capable of being independently enabled or disabled; and
a client platform including an interface which permits end users access to the Customer Feedback System functionality provided in the set of modules to enter requests;
wherein the server maintains only the client selectable modules and provides processing of data received from end users for the client.

19. The system as recited in claim 18, wherein the server also maintains a user interface for accessing functions of the client selectable modules.

20. The system as recited in claim 18, wherein the server includes a URL Scan Module to restrict access to network resources.

21. The system as recited in claim 18, wherein the server includes a read-only database cache accessed by the client selectable modules.

22. The system as recited in claim 18, wherein the server includes a Virtual File System accessible by the client selectable modules.

23. The system as recited in claim 18, wherein the server includes a String Localization Module to replace indicated text with text in a user selected language.

24. The system as recited in claim 18, wherein one of the user selectable modules implements functionality for registering software beta testers.
